(19) United States
(12) Patent Application Publication
(10) Pub. No.: US 2024/0070316 A1
(43) Pub. Date: Feb. 29, 2024

(54) TECHNIQUES FOR PROVIDING A PRIVACY-BASED DATA SHARING PROTOCOL

(71) Applicant: SNICKERDOODLE LABS, INC., San Jose, CA (US)

(72) Inventors: Charles William SIBBACH, Paso Robles, CA (US); Jonathan Michael PADILLA, San Jose, CA (US); Lucas Duffield NOVAK, Palo Alto, CA (US); Robert Alexander MCCOMB, San Jose, CA (US); Scott DAVIS, Milpitas, CA (US); Todd Allen CHAPMAN, Palo Alto, CA (US); Varun PARTHASARATHY, La Center, WA (US)

(21) Appl. No.: 18/240,510

(22) Filed: Aug. 31, 2023

Related U.S. Application Data
(60) Provisional application No. 63/402,928, filed on Aug. 31, 2022.

(51) Int. Cl. G06F 21/62; G06Q 20/36; H04L 9/00

(52) U.S. Cl. CPC G06F 21/6245; G06Q 20/36; H04L 9/50

(57) ABSTRACT

Techniques for a privacy-based user data sharing protocol disclose a system that receives a request to consent to share user data with a subscriber device. The system identifies, based on the request, a smart contract associated with the subscriber device. The smart contract comprises one or more conditions for collecting and managing the user data. The system generates a token based on the smart contract, in which the token indicates consent by a user to share the user data with the subscriber device according to the one or more conditions. The system records the generated token to a blockchain.

### CROSS-REFERENCE TO RELATED APPLICATIONS

This patent application claims priority to U.S. Provisional Patent Application Ser. No. 63/402,928, filed on Aug. 31, 2022, entitled “TECHNIQUES FOR PROVIDING A PRIVACY-BASED DATA SHARING PROTOCOL”, which is herein incorporated by reference in its entirety.

### TECHNICAL FIELD

The present disclosure generally relates to data management, and more specifically, to techniques for providing a decentralized platform for controlling user data privacy and sharing.

### BACKGROUND

Businesses have increasingly commoditized user data as a key asset. For instance, many websites use cookies, or tools that allow businesses to track user online habits and repackage the data as market analytics or ads. The user data obtained provides valuable insights on individual behavior, such as consumer preferences, financial habits, and Internet usage. Consequently, “data subscribers” such as businesses are able to leverage user data in targeting advertisements to individuals, conducting market research, tracking user activity, and even selling the user data to third parties. Further, technological advancements have enabled businesses to use state-of-the art techniques such as providing user data as input for training machine learning algorithms to analyze and predict user behavior. Such techniques may involve substantial computing resources.

Despite the inherent value of user data, “owners” of the user data (the users themselves) often lack meaningful control and visibility over how their data is collected, stored, and managed. Further, collection, management, and storage are all often outsourced to third-party entities, leading to de-facto ownership of user data through the consolidation of roles.

### SUMMARY

An embodiment presented herein discloses a computer implemented method. The method generally includes receiving, by execution of one or more processors, a request to consent to share user data with a subscriber device. The request specifies one or more parameters. The method also generally includes identifying, based on the request, a smart contract associated with the subscriber device that matches the one or more parameters. The smart contract comprises one or more conditions for collecting and managing the user data. A token is generated based on the smart contract. The token indicates consent by the user to share user data with the subscriber device according to the one or more conditions. The generated token is recorded to a blockchain.

Another embodiment presented herein discloses a system having one or more processors and a memory storing a plurality of instructions. The plurality of instructions, when executed on the one or more processors, causes the system to receive a request to consent to share user data with a subscriber device. The request specifies one or more parameters. The system identifies, based on the request, a smart contract associated with the subscriber device that matches the one or more parameters. The smart contract comprises one or more conditions for collecting and managing the user data. A token is generated based on the smart contract. The token indicates consent by the user to share user data with the subscriber device according to the one or more conditions. The generated token is recorded to a blockchain.

Yet another embodiment presented herein discloses a computer-readable storage medium storing a plurality of instructions. The plurality of instructions, when executed on the one or more processors, causes the system to receive a request to consent to share user data with a subscriber device. The request specifies one or more parameters. The system identifies, based on the request, a smart contract associated with the subscriber device that matches the one or more parameters. The smart contract comprises one or more conditions for collecting and managing the user data. A token is generated based on the smart contract. The token indicates consent by the user to share user data with the subscriber device according to the one or more conditions. The generated token is recorded to a blockchain.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates a computing environment in which a privacy-based user data sharing protocol is provided, according to an embodiment;

FIG. 2 illustrates an environment that may be established for a user data wallet executed by a client device, according to an embodiment;

FIG. 3 illustrates an environment that may be established for a data insight service executed by a computing system, according to an embodiment;

FIG. 4 illustrates a block diagram of a computing system configured to provide a data insight service that operates under a privacy-based user data sharing protocol, according to an embodiment;

FIG. 5 illustrates a block diagram of a client device configured to operate under a privacy-based user data sharing protocol, according to an embodiment;

FIG. 6 illustrates a method for generating a consent contract for collecting user data from client devices, according to an embodiment;

FIG. 7 illustrates a method for generating a consent token enabling sharing user data with a subscriber device, according to an embodiment; and

FIG. 8 illustrates a method for processing subscriber queries for user data under a privacy-based user data sharing protocol, according to an embodiment.

### DETAILED DESCRIPTION

Embodiments of the present disclosure provide techniques and an architecture for providing a privacy-based data sharing protocol. More particularly, the techniques described herein provide a decentralized approach enabling a user to securely and privately collect, manage, and store data. The approach also enables interested parties (e.g., businesses, other individuals, etc.) to extract insights and other analytics from the data in a manner that achieves compute resource efficiency, data privacy, and security.

As further described herein, the privacy-based data sharing protocol leverages decentralized blockchain technology to establish permissionless, relatively trustless, and available properties under which a user may manage and share data with entities consented to by the user. In an embodiment, a blockchain network platform may provide smart contract and data processing services that execute as part of the protocol to identify such entities, also referred to herein as “data subscribers,” and establish specific permissions for types of data that may be shared with the data subscribers. For example, a smart contract service may generate “consent contracts” on behalf of the data subscribers, which enables the data subscriber to create a data pool by signaling a request for certain data and provide a means for users to consent to sharing such data. Client devices of users consenting to share their data with a particular data subscriber may call to a specific consent contract and be issued a non-transferable non-fungible token (NFT) which serves as user consent for sharing the data with the data subscriber. As another example, a data management service may process the data to provide insights and other analytics such that raw user data does not have to be sent to the data subscriber.

As also further described herein, the privacy-based data sharing protocol provides a “data wallet” which may serve as a client interface within the protocol that enhances data ownership for the user by assisting the user in controlling and consenting to the collection, storage, usage of user data. In doing so, the data wallet may include functionalities for securely storing user data, collecting and mining the data, aggregating various types of data, managing consents within the protocol, localized data processing, identity management, and others. Further, the protocol incorporates edge-based networks (e.g., within the blockchain network platform) in instances where a client device of a user shares data for ingestion and analysis to allow for more efficient processing and transfer of raw data from the client and analytics to a requesting data subscriber.

As also further described herein, the protocol may provide additional functions to allow users to have greater autonomy and ownership over their data. For example, the present approach and architecture enables data subscribers and other entities to transfer “rewards” such as NFTs and compensation to user data wallets for sharing their data (or taking steps to share their data).

Advantageously, embodiments of the present disclosure incorporate decentralized components of a network to provide users over the network with greater autonomy, protection, and ownership over user data. Previous data sharing methods, in which data subscribers rely on centralized aggregators and tools such as cookies to collect, store, and manager user data, are associated with serious privacy and security issues that provide users with little transparency over how the user data is collected, used, and managed. The present disclosure provides a transparent approach for collecting, storing, and managing user data.

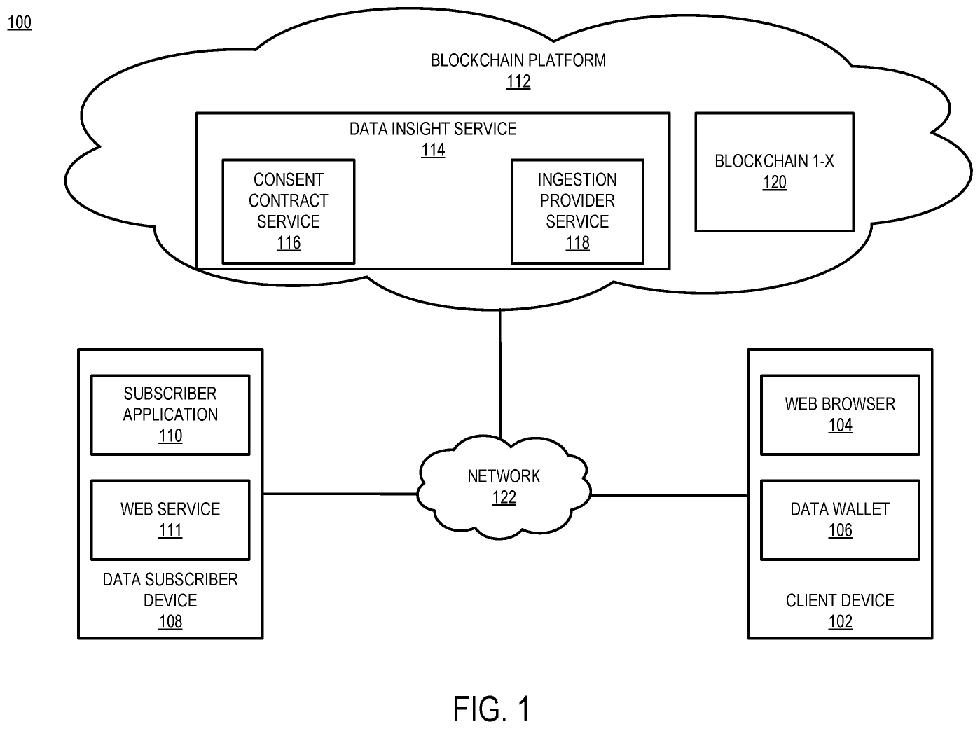

Turning now to FIG. 1, an example computing environment 100 in which the privacy-based data sharing protocol may be deployed is shown. Illustratively, the computing environment 100 includes a client device 102, data subscriber device 108, and a blockchain platform 112, each interconnected via a network 122 (e.g., the Internet).

The illustrative client device 102 represents a computing system operated by an individual user. The client device 102 may be embodied as any physical computing device (e.g., a desktop computer, laptop computer, workstation, etc.) or a virtual computing device (e.g., a virtual machine instance executing on a physical computing device or on a cloud platform). As shown, the client device 102 includes a web browser 104 and a data wallet 106. The web browser 104 is a software application that accesses content provided by websites over the network 122 and presents the content on a display of the client device 102.

In an embodiment, the data wallet 106 is an end-user-side interface that provides functions for a user to manage collection, storage, and usage of the user's data. As further described herein, the data wallet 106 performs various features, including secure data storage, individualized data mining, data aggregation, consent management, localized data processing and submission, reward discovery and management, and identity management. Generally, the data wallet 106 receives queries formulated according to the data sharing protocol from data subscribers and execute computations to generate insights. The data wallet 106 may be embodied as a plugin or extension that integrates with the web browser 104 (either natively or otherwise, e.g., by downloading and installing via a browser extension repository). In some embodiments, the data wallet 106 may be a standalone application executing on the client device 102, in which the standalone application leverages application programming interfaces (APIs) and API hooks for integrating with other applications on the client device 102.

The illustrative data subscriber device 108 represents one or more computing systems and/or pool of computing resources of an entity, such as a large corporation, enterprise, or other organization, that may use the data of individual users as part of its routine operations, such as by collecting data, aggregating data, purchasing data, generating analytics, and the like. The data subscriber device 108 includes a subscriber application 110 and a web service 111. The data subscriber device 108 may execute the web service 111 to deliver content to the web browser 104 of the client device 102. The content may include code or data that may communicate with the web browser 104 and the data wallet 106 to request consent for data (or query for data following consent), as will be further described herein.

The subscriber application 110 may be a server application for communicating with services within the blockchain platform 112 and the data wallet 106. For example, the subscriber application 110 may initiate the generation process for smart contracts to be used in collecting data and formulate queries for user data from the client device 102 according to the techniques disclosed herein. In an embodiment, the subscriber application 110 may formulate queries to share data requests that are enforced according to a decentralized autonomous organization (DAO) and may be stored on a content-addressable distributed network (e.g., a location within the blockchain platform 112) to ensure tamper resistance. Queries allow a data subscriber to define who data is to be requested from, what types of computations to execute, where to send data insights and analytics, and rewards for sending the insight. In an embodiment, the queries are content-addressed so that users and entities other than the data subscriber are able to access the query and verify the validity thereof.

The illustrative blockchain platform 112 represents a decentralized blockchain network platform on which blockchain-based applications and services may execute. In an embodiment, the blockchain platform 112 is an Ethereum Virtual Machine (EVM)-compatible blockchain subnet that is scalable. As shown, the blockchain platform 112 includes a data insight service 114, which itself may include a consent contract service 116 and an ingestion provider service 118. The blockchain platform 112 also includes one or more blockchains 1-x 120 on which various types of data may be stored.

The consent contract service 116 may be embodied as a smart contract service that generates “consent contracts” for a data subscriber device 108. A consent contract represents a data pool and signals an indication for requesting to subscribe to data as well as facilitates the exchange of data insights. In an embodiment, the consent contract service 116 may also generate, from a consent contract, additional contracts. In an embodiment, the consent contract service 116 may also generate a “consent token” which indicates that a user (e.g., of the client device 102) has consented to share data in accordance to a specific consent contract. The consent token may be embodied as, for example, a non-transferable non-fungible token (NFT) that conforms to the ERC-721 standard. A consent token represents a consent of a user or client device to participate in the data pool with which the token is associated. In the event that a user no longer wishes to share data within the data pool, the consent contract service 116 may “burn” or repudiate the token.

The ingestion provider service 118 may receive locally processed data insights from the data wallet 106 (e.g., generated in response to a query sent by a data subscriber device 108) and store the insights, e.g., as discretized events, and manage access to the stored insights.

The blockchain platform 112 may also be associated with a DAO, which serves as a decentralized governance mechanism for the embodiments presented herein. The DAO creates a decentralized means for managing authorized queries, serves as a certificate authority for code distribution, and controls a whitelist and blacklist of users and entities.

The data subscriber device 108 may know how many individuals have consented to share data and can respond to queries. In an embodiment, a fee structure may be incorporated within the protocol described herein, in which the consent contract service 116 (or other token generating service) may generate a token that is used to pay subnet gas fees (blockchain transaction fees), protocol fees, and voting in the DAO.

Although FIG. 1 depicts the consent contract service 116 and ingestion provider service 118 as being integrated within the data insight service 114, other embodiments may provide each of the services 114, 116, and 118 as separate services altogether.

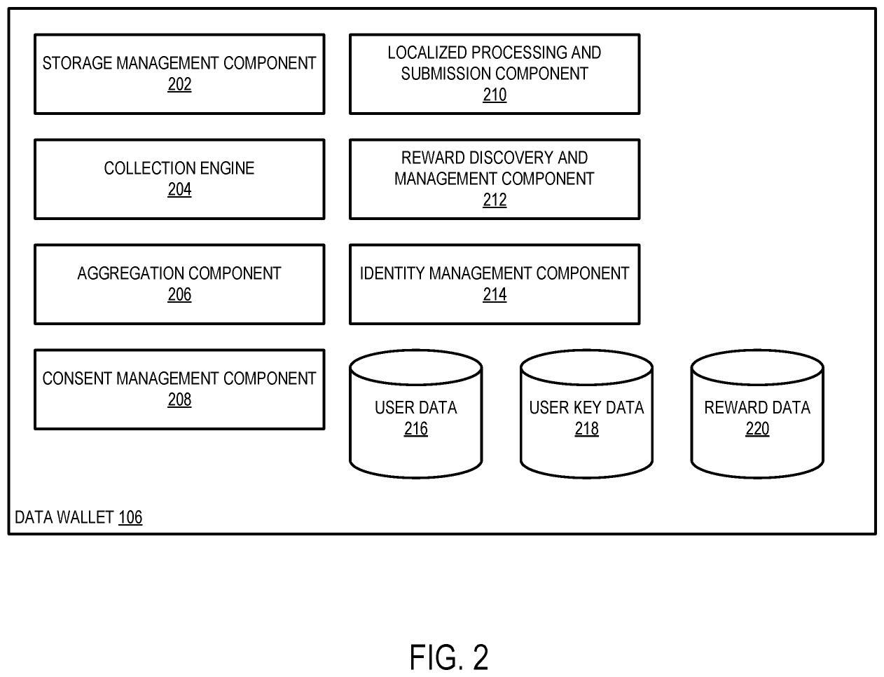

Referring now to FIG. 2, the data wallet 106 may provide the following environment during execution on the client device 102. The data wallet 106 may include a storage management component 202, a collection engine 204, an aggregation component 206, a consent management component 208, a localized processing and submission component 210, a reward discovery and management component 212, and an identity management component 214. The data wallet 206 may also manage stores of user data 216, user key data 218 (e.g., public and private keys, digital signatures, etc.), and reward data 220.

In an embodiment, the storage management component 202 may be embodied as any hardware, software, or circuitry to manage storage a user data 216 (e.g., which may comprise personal identifiable information, usage data, behavioral data, website engagement data, and so on) In some embodiments, the storage for the user data 216 may be implemented as an in-memory database of key-value pairs, e.g., using the local storage of the web browser 104. In other embodiments, other storage approaches such as indexedDB may be used.

The collection engine 204 assists in collecting various types of data 216 on behalf of the user. Such data mining provides highly accurate data, which can be used in other situations (e.g., in data monetization). In an embodiment, the user data 216 is associated with three properties: whether explicit or implicit, whether first or third party, and whether authenticated or unauthenticated.

Regarding whether user data 216 is explicit or implicit, the collection engine 204 may collect data via explicit or implicit methods. Explicit data pertains to data that is directly provided by the user, such as personal identifying information (e.g., name, age, wallet address, etc.). In an embodiment, the user may manually input explicit data. However, other embodiments include the web browser 104 providing an in-browser event capture to passively collect the data, e.g., collecting information about what websites a user has visited. Implicit data pertains to data that is generated by user action, e.g., using a wallet address of the user to learn that the user has swapped specific tokens or played a Web 3.0-based game.

Regarding whether user data 216 is first or third party data, the collection engine 204 may collect such data from various sources. First party data pertains to data that is obtained directly from the user (e.g., manually input by the user). Third party data pertains to data that is obtained from a source other than the user, even if provided by the user (e.g., if a user imports name data from a local state government database).

Regarding whether user data 216 is authenticated or unauthenticated, authenticated data pertains to data having an origin and validity that can be verified through cryptographic techniques. For example, the address of the data wallet 106 can be authenticated based on a signed message from that address. Third party data can be authenticated if the data has a known identity (e.g., the public key of the aforementioned local state government database is known, and the collection engine 204 receives data signed by that key).

The aggregation component 206 may process the collected implicit and explicit data using a variety of aggregation techniques. Such techniques may involve aggregating on-chain data, data from third-party sources, digital identities, and the like.

The consent management component 208 receives and processes communications from the data subscriber device 108 and services in the blockchain platform 112 pertaining to consenting the sharing of data. For instance, the consent management component 208 may receive communications from the contract consent service 116 or the data subscriber device 108 including one or more transactions to be signed. The consent management component 208 may also receive and process queries transmitted by the data subscriber device 108 pertaining to a data pool to which the user has consented data sharing.

The localized processing and submission component 210 executes computations transmitted by the data subscriber device 108 (e.g., in response to a formulated query) or from the consent contract service 116 to generate data insights and analytics. Executing the computations locally ensures that only analyses and computations to which the user has consented can execute on the user data 216. Further, the local processing provides an efficient means for processing data compared to previous techniques of transmitting raw data to a remote location for processing. Under the methods of the present disclosure, insights are transmitted to the requesting subscriber device instead of the raw data itself, which also contributes to greater privacy of the raw data.

The reward discovery and management component 212 facilitates the receipt of rewards (e.g., monetary compensation, NFTs, etc.) that the protocol may grant to the user for sharing user data 216. The reward discovery and management component 212 may query services within the blockchain platform 112 or known data subscribers to identify instances where rewards may be available. For example, the web service 111 may include content that allows the reward discovery and management component 212 to establish a connection and display available rewards that a user may obtain. The identity management component 214 manages user key data 218 which may include public and private cryptographic key pairs and digital signature data associated with the user.

The data wallet 106 may also include a distributed runtime library, which uses iframes of the web browser 104 to run plugins for data processing and integration with the data wallet 106. Doing so isolates the processing operations of the data wallet 106 components from that of the web browser 104. To ensure validity of the plugins, the data wallet 106 uses the iframe to enforce the legitimacy of the code by verifying certificates and checksums with the DAO whitelist. Doing so provides the user with a trustless method of verifying that the user data 216 is being processed and safely maintained.

Further, the DAO may maintain a whitelist of authorized plugins determined by governance. The whitelist of authorized plugins ensures that accepted logic is determined by token holders and enforces the integrity of the plugins at execution level. In an embodiment, the certificate registry of the DAO is implemented as a ERC-721 smart contract in which the token uniform resource identifier (URI) includes the checksum and domain name.

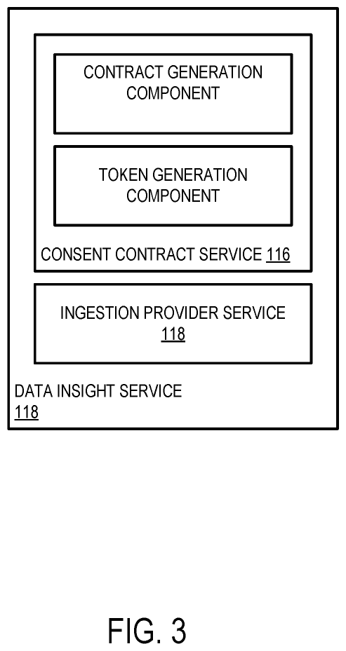

Referring now to FIG. 3, the data insight service 118 may provide the following environment during execution, e.g., on a computing system operating on the blockchain platform 112. As shown, the data insight service 118 includes the consent contract service 116 and the ingestion provider service 118.

As stated, the consent contract service 116 may generate a consent contract in response to a request from the data subscriber device 108. In an embodiment, the consent contract service 116 may operate under a smart contract factory pattern, which is a gas-efficient way to generate upgradeable smart contracts. Under such a pattern, a smart contract is responsible for creating other contracts, which creates a trustless means for a data subscriber to deploy consent contracts and improves data security by creating auditable contracts with a defined scope. Further, the contract factory pattern may also be implemented with an upgradable beacon pattern to optimize for gas.

In an embodiment, the consent contract service 116 generates consent contracts using proxies and upgradeable beacon contracts, which is made possible because the consent factory contract will create new proxy consent contracts. Such proxy consent contacts typically include minimal information, only storing state information and a pointer to the upgradable beacon contract. The upgradeable beacon contract points to the current implementation of the consent contract. This deployed contract includes all functions and stored values of the consent contract, which proxy consent contracts inherent. To update a consent contract, the consent contract service 116 may deploy a new consent contract and change the upgradable beacon to point to the new contract. All previously deployed and newly created proxy consent contracts inherit the functionality defined in the new contract.

In an embodiment, the consent contract service 116 may facilitate meta transactions, which allow another entity to pay for a user's gas (blockchain transaction) fees. Every state-changing transaction (any transaction with a gas fee) may have meta transactions enabled.

In an embodiment, the consent contract service 116 may generate consent tokens, which may be a non-transferable NFT that conforms to the ERC-721 standard. Further, the consent contract service 116 may also generate platform tokens, which are used to pay for blockchain subnet gas fees, protocol fees, and voting in the DAO. The platform token may a native non-ERC-20 token within the subnet. In some embodiments, the platform token is an ERC-20 token representing votes in the DAO. The DAO itself may have a smart contract allowing conversion between these aforementioned platform tokens.

The ingestion provider service 118 is a DAO-approved allows a data subscriber to access insights generated by the data wallet 106. More particularly, a data wallet 106, in responding to a data subscriber query, performs computations specified in the query and transmits the output of the computation (e.g., insights on the request data) to the ingestion provider service 118. In turn, the ingestion provider service 118 stores and provides access to the insights to the data subscriber.

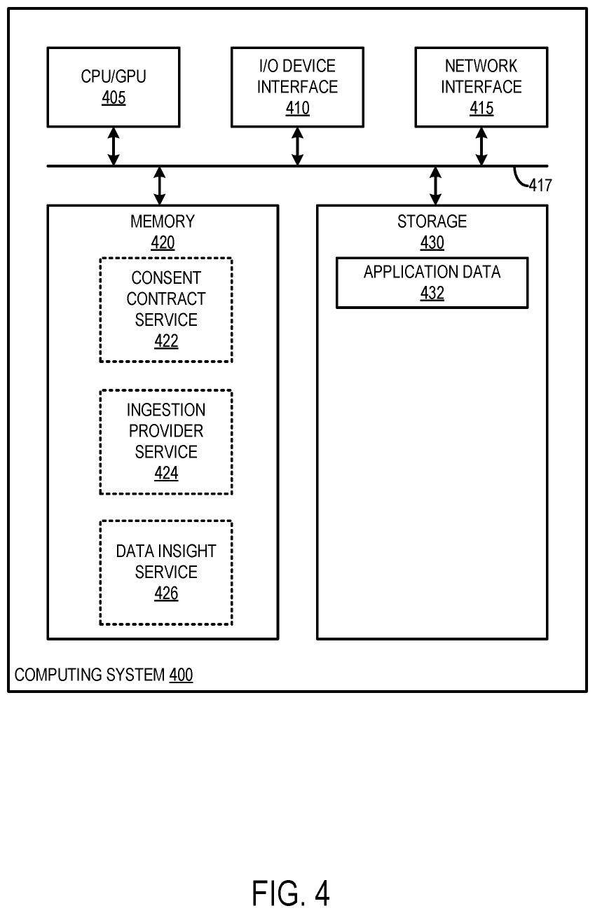

Referring now to FIG. 4, a block diagram of a computing system 400 configured to operate one or more services of the privacy-based data sharing protocol within the blockchain platform 112 is shown. The computing system 400 includes, without limitation, a central processing unit and/or graphics processing unit (CPU/GPU) 405, an input/output (I/O) device interface 410, a network interface 415, a memory 420, and a storage 430, each interconnected via a hardware bus 417. Of course, the actual computing system 400 will include a variety of additional hardware components not shown. Additionally, in some embodiments, one or more of the illustrative components may be incorporated in, or otherwise form a portion of, another component.

The CPU/GPU 405 retrieves and executes programming instructions stored in the memory 420. The CPU/GPU 405 may be embodied as one or more processors, each processor being a type capable of performing the functions described herein. CPU/GPU 405 is included to be representative of a single CPU, multiple CPUs, a single CPU having multiple processing cores, a single GPU, multiple GPUs, a single GPU having multiple processing cores, and/or a combination. For example, the CPU 405 may be embodied as a single or multi-core processor(s), a microcontroller, or other processor or processing/controlling circuit. In some embodiments, the CPU 405 may be embodied as, include, or be coupled to a field programmable gate array (FPGA), an application-specific integrated circuit (ASIC), reconfigurable hardware or hardware circuitry, or other specialized hardware to facilitate performance of the functions described herein. The hardware bus 417 is used to transmit instructions and data between the CPU 405, storage 430, network interface 415, and the memory 420. The memory 420 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

The network interface 415 may be embodied as any hardware, software, or circuitry (e.g., a network interface card) used to connect the computing system 400 to other components within the blockchain platform 112 and/or over the network 122. For example, the network interface 415 may be embodied as any communication circuit, device, or collection thereof, capable of enabling communications over the network 122 between the computing system 400 and other devices (e.g., the client device 102, data subscriber device 108, etc.). The network interface 415 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the network interface 415 may include a network interface controller (NIC, not shown), embodied as one or more add-in-boards, daughtercards, controller chips, chipsets, or other devices that may be used by the computing system 400 for network communications with remote devices. For example, the NIC may be embodied as an expansion card coupled to the I/O device interface 410 over an expansion bus such as PCI Express.

The I/O device interface 410 allows I/O devices to communicate with hardware and software components of the computing system 400. For example, the I/O device interface 410 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O device interface 410 may form a portion of a system-on-a-chip (SoC) and be incorporated, along with one or more of the CPU 405, the memory 420, and other components of the computing system 400. The I/O devices may be embodied as any type of I/O device connected with or provided as a component to the computing system 400, such as keyboards, mice, and printers.

Illustratively, the memory 420 includes one or more of a consent contract service 422, ingestion provider service 424, and a data insight service 426, which perform the functions described relative to the consent contract service 116, ingestion provider service 118, and data insight service 114, respectively. The storage 430 may be embodied as any type of devices configured for short-term or long-term storage of data such as, for example, memory devices and circuits, memory cards, hard disk drives (HDDs), solid-state drives (SSDs), or other data storage devices. The storage 430 may include a system partition that stores data and firmware code therefor. The storage 430 may also include an operating system partition that stores data files and executables for an operating system. Illustratively, the storage 430 includes application data 432, which may be indicative of data used by any of the consent contract service 422, ingestion provider service 424, and/or the data insight service 426 to carry out the data sharing protocol functions described herein.

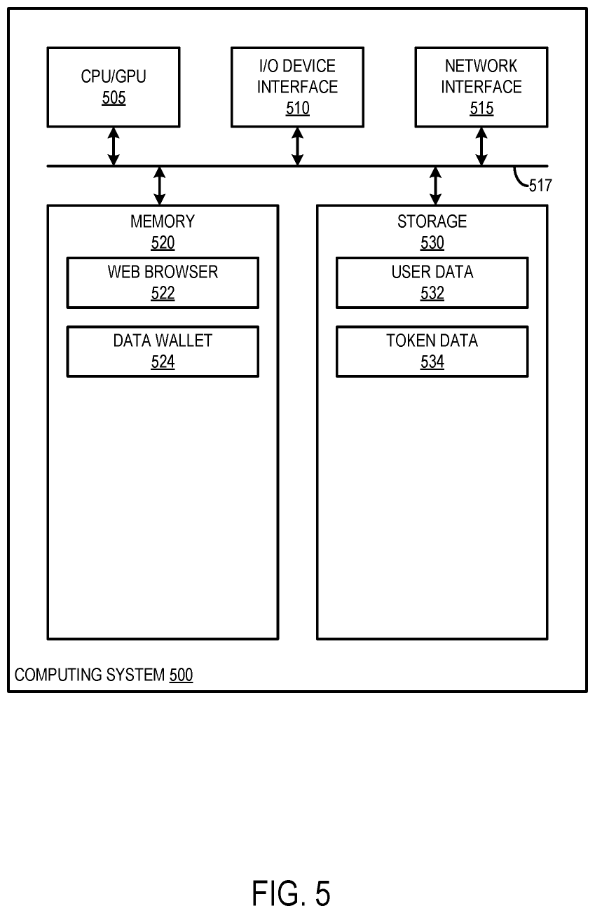

Referring now to FIG. 5, a block diagram of a computing system 500 configured to execute a user data wallet within a privacy-based data sharing protocol is shown. The computing system 500 includes, without limitation, a central processing unit and/or graphics processing unit (CPU/GPU) 505, an input/output (I/O) device interface 510, a network interface 515, a memory 520, and a storage 530, each interconnected via a hardware bus 517. Of course, the actual computing system 500 will include a variety of additional hardware components not shown. Additionally, in some embodiments, one or more of the illustrative components may be incorporated in, or otherwise form a portion of, another component.

The CPU/GPU 505 retrieves and executes programming instructions stored in the memory 520 and performs similarly to the CPU/GPU 405 described herein. The hardware bus 517 is used to transmit instructions and data between the CPU 505, storage 530, network interface 515, and the memory 520. The memory 520 may be embodied as any type of volatile (e.g., dynamic random access memory, etc.) or non-volatile memory (e.g., byte addressable memory) or data storage capable of performing the functions described herein and is similar to the memory 420 described herein.

The network interface 515 may be embodied as any hardware, software, or circuitry (e.g., a network interface card) used to connect the computing system 500 to other components over the network 122 and is similar to the network interface 415 described herein. The I/O device interface 510 allows I/O devices to communicate with hardware and software components of the computing system 500 and is similar to the I/O device interface 410 described herein.

Illustratively, the memory 520 includes a web browser 522 and data wallet 524, which perform the functions described relative to the web browser 104 and data wallet 106, respectively. The storage 530 may be embodied as any type of devices configured for short-term or long-term storage of data such as, for example, memory devices and circuits, memory cards, hard disk drives (HDDs), solid-state drives (SSDs), or other data storage devices and is similar to the storage 430 described relative to FIG. 4. Illustratively, the storage 530 includes user data 532 and token data 534, which may be stored as part of the data wallet 524.

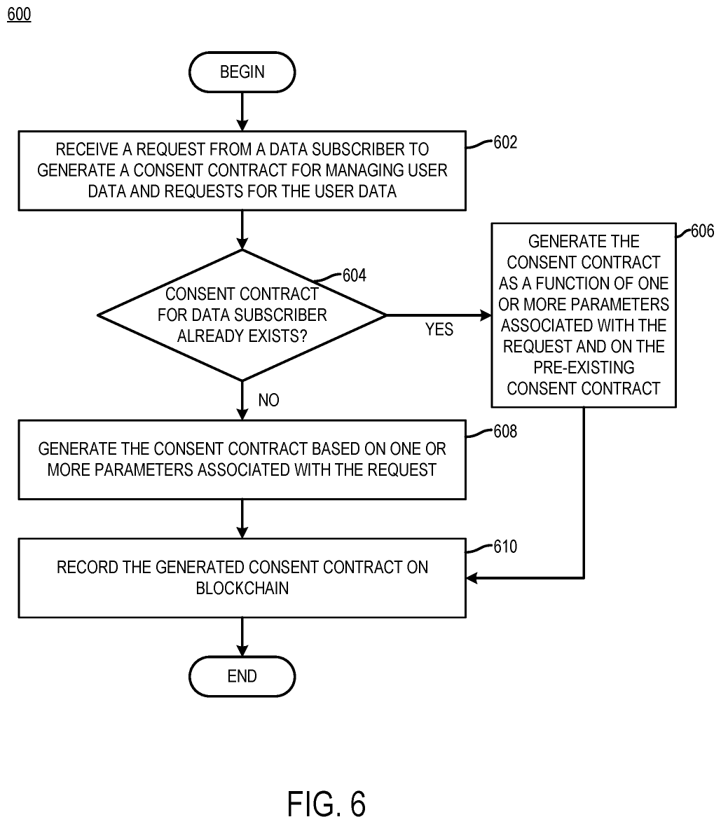

Referring now to FIG. 6, the consent contract service 116, in operation, may perform a method 600 for generating a smart contract for consenting the sharing of user data with a data subscriber. As shown, the method 600 begins in block 602, in which the consent contract service 116 receives a request from a data subscriber (e.g., the data subscriber device 108) to generate a consent contract for managing user data and requests for the user data. The request may include one or more parameters, such as the type of data to be obtained, the types of parties from whom to obtain the data, how the data would be used, and so son.

In block 604, the consent contract service 116 determines whether a consent contract associated with the data subscriber already exists. If so, then in block 606, the consent contract service 116 generates the consent contract as a function of the one or more parameters associated with the request as well as the preexisting consent contract associated with the data subscriber. The generated consent contract as a result inherits the functions and stored values of the preexisting consent contact. If no consent contract associated with the data subscriber exists, then in block 608, the consent contract service 116 generates the consent contract based on one or more parameters associated with the request. In block 610, the consent contract service 116 records the generated consent contract on the blockchain (e.g., the blockchain 120).

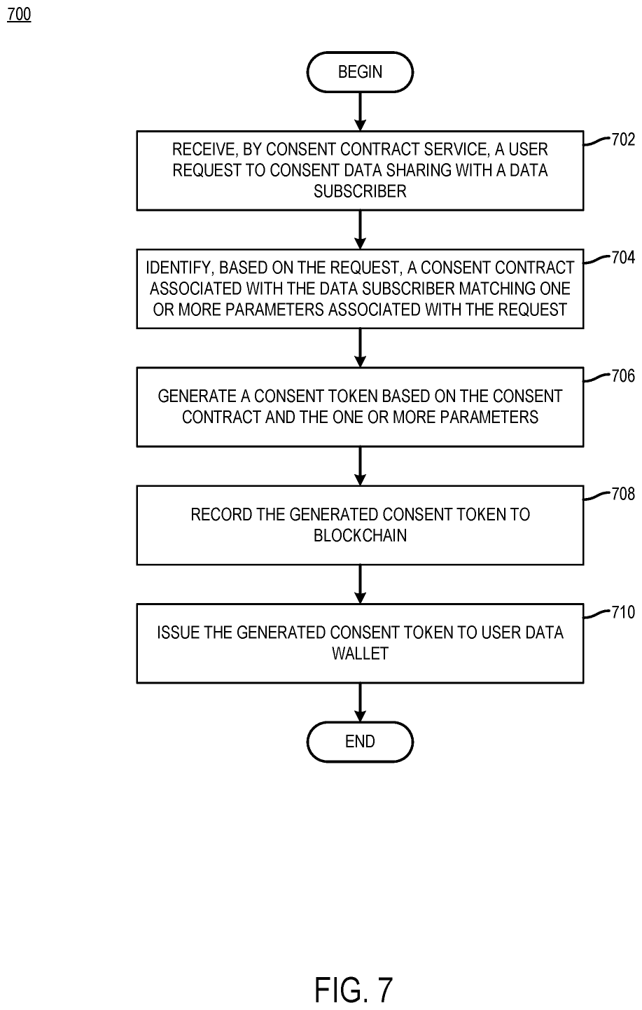

Referring now to FIG. 7, the consent contract service 116, in operation, may perform a method 700 for generating a non-transferable token indicating a user consent for the sharing of user data with a data subscriber. As shown, the method 700 begins in block 702, in which the consent contract service 116 receives a user request to consent to data sharing with a data subscriber (e.g., the data subscriber device 108). In block 704, the consent contract service 116 identifies, based on the request, a consent contract associated with the data subscriber matching one or more parameters associated with the request.

In block 706, the consent contract service 116 generates a consent token based on the consent contract and the one or more parameters. In block 708, the consent contract service 116 records the generated consent token to the blockchain (e.g., the blockchain 120). In block 710, the consent contract service 116 issues the generated consent token to the data wallet of the user on client device 102.

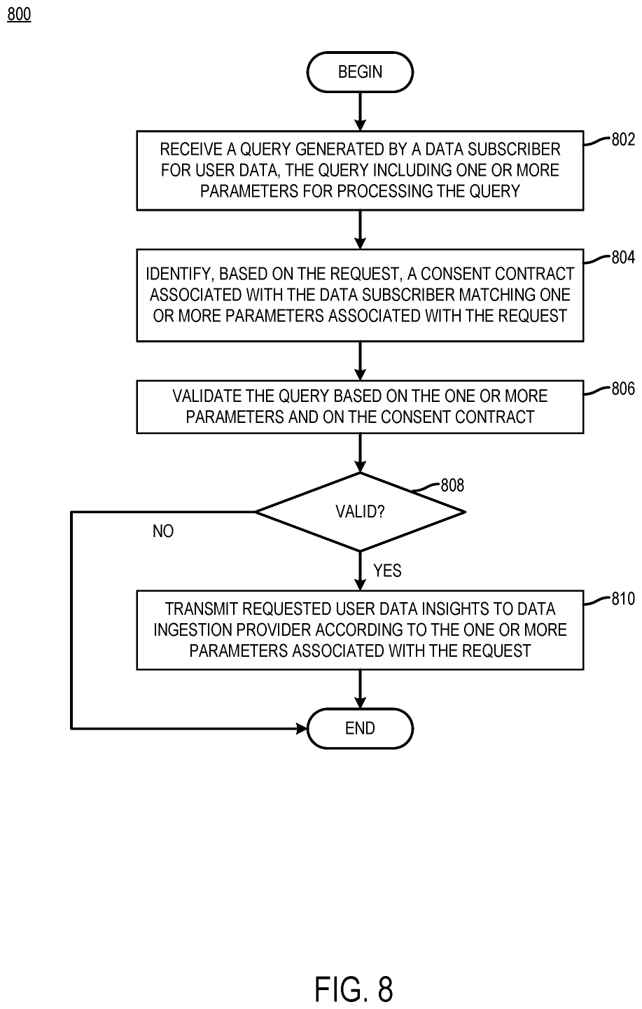

Referring now to FIG. 8, the consent contract service 116, in operation, may perform a method 800 for validating queries for user data generated by data subscribers and sent to client devices. The protocol provides a query language that enables data subscribers to request data and perform computations to consenting users. The query may be structured as a JSON file containing information on eligibility requirements, rewards, data to be collected, what processing to perform, and an address to send the processed data or insights. The allowed functions and syntax of the query language may be enforced by the DAO and determined by token holders, which allow for enforcement of user privacy.

As shown, the method 800 begins in block 802, in which the consent contract service 116 receives a query generated by a data subscriber (e.g., the data subscriber device 108) for user data. The query includes one or more parameters for processing the query. For example, the client device 102 may receive the query from the data subscriber device 108 via an event listener in the data wallet 106. Following local processing of the query and specified computations, invoke a call to the consent contract service 116 to validate the query.

In block 804, the consent contract service 116 identifies, based on the request, a consent contract associated with the data subscriber that matches one or more parameters associated with the request, in which the one or more parameters may include types of data being requested, computations to be performed, an address for insights to be received, etc. In block 806, the consent contract service 116 validates the query based on the one or more parameters and on the consent contract. In block 808, the consent contract service 116 determines whether the query is valid. If not, then the method 800 ends. Otherwise, in block 810, the consent contract service 116 transmits the requested user data insights to the data ingestion provider service according to the one or more parameters associated with the request.

For the purposes of promoting an understanding of the principles of the present disclosure, reference is made to preferred embodiments and specific language is used to describe the same. It will nevertheless be understood that no limitation of the scope of the disclosure if thereby intended, such alteration and further modifications of the disclosure as illustrated herein, being contemplated as would normally occur to one skilled in the art to which the disclosure relates.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless otherwise defined, all technical terms used herein have the same meaning as commonly understood by one of ordinary skill in the art to which this disclosure belongs.

One aspect of the present disclosure provides a method of sharing user data with one or more parties within a decentralized Internet platform.

Another aspect of the present disclosure is a system configured to manage the sharing of user data with one or more parties within a decentralized Internet platform. The system can be implemented in hardware, software, firmware, or combinations of hardware, software and/or firmware. In some examples, the system and methods described in this specification may be implemented using a non-transitory computer readable medium storing computer executable instructions that when executed by one or more processors of a computer cause the computer to perform operations. Another aspect of the present disclosure provides all that is described and illustrated herein.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

1. A system comprising:
one or more processors;
a memory storing a plurality of instructions, which, when executed on the one or more processors, causes the system to:
receive a request to consent to share user data with a subscriber device, the request specifying one or more parameters;
identify, based on the request, a smart contract associated with the subscriber device that matches the one or more parameters, wherein the smart contract comprises one or more conditions for collecting and managing the user data;
generate a token based on the smart contract, the token indicating consent by a user to share the user data with the subscriber device according to the one or more conditions; and
record the generated token to a blockchain.

2. The system of claim 1, wherein the plurality of instructions further causes the system to issue the generated token to a data wallet managing the user data.

3. The system of claim 1, wherein the token is a non-fungible token (NFT).

4. The system of claim 1, wherein the plurality of instructions further causes the system to:
receive, from a client device, a query generated by the subscriber device to access the user data;
identify the smart contract associated with the query;
validate the query based on the smart contract; and
upon a determination that the query is valid, transmit an indication of a validity of the query to the client device.

5. The system of claim 4, wherein the plurality of instructions further causes the system to:
receive, from the client device, the user data; and
generate one or more insights based on the user data.

6. The system of claim 5, wherein the plurality of instructions further causes the system to transmit the one or more insights to the subscriber device via an ingestion provider.

7. The system of claim 1, wherein the plurality of instructions further causes the system to:
receive, from the subscriber device, a request to generate the smart contract; and
upon a determination that a preexisting smart contract is present, generate the smart contract as a function of the preexisting smart contract.

8. A computer-implemented method comprising:
receiving, by execution of one or more processors, a request to consent to share user data with a subscriber device, the request specifying one or more parameters;
identifying, based on the request, a smart contract associated with the subscriber device that matches the one or more parameters, wherein the smart contract comprises one or more conditions for collecting and managing the user data;
generating a token based on the smart contract, the token indicating consent by the user to share the user data with the subscriber device according to the one or more conditions; and
recording the generated token to a blockchain.

9. The computer-implemented method of claim 8, further comprising issuing the generated token to a data wallet managing the user data.

10. The computer-implemented method of claim 8, wherein the token is a non-fungible token (NFT).

11. The computer-implemented method of claim 8, further comprising:
receiving, from a client device, a query generated by the subscriber device to access the user data;
identifying the smart contract associated with the query;
validating the query based on the smart contract; and
upon determining that the query is valid, transmitting an indication of a validity of the query to the client device.

12. The computer-implemented method of claim 11, further comprising:
receiving, from the client device, the user data; and
generating one or more insights based on the user data.

13. The computer-implemented method of claim 12, further comprising transmitting the one or more insights to the subscriber device via an ingestion provider.

14. The computer-implemented method of claim 8, further comprising:
receiving, from the subscriber device, a request to generate the smart contract; and
upon determining that a preexisting smart contract is present, generating the smart contract as a function of the preexisting smart contract.

15. A computer-readable storage medium storing a plurality of instructions, which, when executed by one or more processors, causes a system to:
receive a request to consent to share user data with a subscriber device, the request specifying one or more parameters;
identify, based on the request, a smart contract associated with the subscriber device that matches the one or more parameters, wherein the smart contract comprises one or more conditions for collecting and managing the user data;
generate a token based on the smart contract, the token indicating consent by the user to share the user data with the subscriber device according to the one or more conditions; and
record the generated token to a blockchain.

16. The computer-readable storage medium of claim 15, wherein the plurality of instructions further causes the system to issue the generated token to a data wallet managing the user data.

17. The computer-readable storage medium of claim 15, wherein the token is a non-fungible token (NFT).

18. The computer-readable storage medium of claim 15, wherein the plurality of instructions further causes the system to:
receive, from a client device, a query generated by the subscriber device to access the user data;
identify the smart contract associated with the query;
validate the query based on the smart contract; and
upon a determination that the query is valid, transmit an indication of a validity of the query to the client device.

19. The computer-readable storage medium of claim 18, wherein the plurality of instructions further causes the system to:
receive, from the client device, the user data;
generate one or more insights based on the user data; and
transmit the one or more insights to the subscriber device via an ingestion provider.

20. The computer-readable storage medium of claim 19, wherein the plurality of instructions further causes the system to:
receive, from the subscriber device, a request to generate the smart contract; and
upon a determination that a preexisting smart contract is present, generate the smart contract as a function of the preexisting smart contract.
